(19) United States
(12) Patent Application Publication
(10) Pub. No.: US 2026/0014727 A1
(43) Pub. Date: Jan. 15, 2026

(54) CUTTING DEVICE, PLATE-SHAPED BODY MANUFACTURING APPARATUS, GYPSUM PLATE MANUFACTURING APPARATUS, AND GYPSUM PLATE MANUFACTURING METHOD

(71) Applicant: YOSHINO GYPSUM CO., LTD., Tokyo (JP)

(72) Inventors: Seigo ISHIBASHI, Tokyo (JP); Yasuaki MURAEDA, Tokyo (JP); Tatsuki NAKANO, Tokyo (JP)

(21) Appl. No.: 18/881,937

(22) PCT Filed: Mar. 27, 2023
(86) PCT No.: PCT/JP2023/012324

§ 371 Date: Jan. 7, 2025

(30) Foreign Application Priority Data
Sep. 29, 2022 (JP) 2022-155885

(51) Int. Cl. B26D 1/12; B28B 11/14; B28B 19/00

(52) U.S. Cl. CPC B26D 1/125; B28B 11/14; B28B 19/0092

(57) ABSTRACT

A cutting device is provided for cutting a conveyed plate-shaped body. The cutting device includes a rotary cutter and a lifting device. The rotary cutter includes a lower unit. The lower unit is disposed below the plate-shaped body, and includes a roll and a lower blade attached to the roll. The lifting device is disposed on the lower unit, and lifts up the plate-shaped body.

### TECHNICAL FIELD

The present disclosure relates to a cutting device, a plate-shaped body manufacturing apparatus, a gypsum plate manufacturing apparatus, and a gypsum plate manufacturing method.

### BACKGROUND ART

In Patent Document 1, a cutting method for a hydraulic molded body is disclosed. In the disclosed method, a pair of cutters each having a saw blade are arranged to face each other with a plate-shaped hydraulic molded body, which is in a wet state, being interposed between the pair of cutters, and the molded body is pressed between the saw blades from both sides to be cut. In the cutting method, the saw blades are swung in a longitudinal direction of the saw blades.

### PRIOR ART DOCUMENTS

### Patent Documents

Patent Document 1: Japanese Unexamined Patent Application Publication No. S53-75586

### SUMMARY OF THE INVENTION

### Problems to be Solved by the Invention

For ceramic products, such as gypsum plates, resin products, and the like, plate-shaped bodies having a plate shape have been manufactured as products, and have been used for various applications.

A manufacturing method for a product of the above plate-shaped body varies depending on the product to be manufactured or the like. For example, the above plate-shaped body is produced by kneading and molding raw materials to form a semi-finished product having a plate shape, and performing cutting, drying, firing, and the like as necessary, while conveying the semi-finished product with a conveying device. When cutting the semi-finished product, a cutting device including a rotary cutter, such as the cutters disclosed in Patent Document 1, has been used in the related art.

However, a cut surface of the plate-shaped body may come into contact with the conveying device disposed downstream of the rotary cutter in the conveying direction of the plate-shaped body. If the cut surface of the plate-shaped body and the conveying device come into contact with each other, a material of the plate-shaped body may be deposited on the conveying device. The deposited material causes flaws or the like on a surface of a subsequent plate-shaped body coming into contact with the conveying device. Moreover, if the cut surface of the plate-shaped body and the conveying device come into contact with each other, the plate-shaped body may be damaged, resulting in production of a defective product that does not satisfy the required standard.

In view of the above problems in the related art, one aspect of the present invention aims to provide a cutting device, which can inhibit a conveying device that conveys a plate-shaped body from coming into contact with a cut surface of the plate-shaped body after cutting, thereby minimizing deposition of a material of the plate-shaped body on the conveying device or damage to the plate-shaped body.

### Means for Solving the Problems

According to one embodiment of the present invention for solving the above problems, there is provided a cutting device for cutting a conveyed plate-shaped body. The cutting device includes a rotary cutter and a lifting device. The rotary cutter includes a lower unit. The lower unit is disposed below the plate-shaped body, and includes a roll and a lower blade attached to the roll. The lifting device is disposed on the lower unit, and lifts up the plate-shaped body.

### Effects of the Invention

According to one embodiment of the present invention, there can be provided a cutting device, which can inhibit a conveying device that conveys a plate-shaped body from coming into contact with a cut surface of the plate-shaped body after cutting, thereby minimizing deposition of a material of the plate-shaped body on the conveying device or damage to the plate-shaped body.

### BRIEF DESCRIPTION OF THE DRAWINGS

FIG. 1 is an explanatory view of a cutting device according to an embodiment of the present invention.

FIG. 2A is an explanatory view of a positional relationship between a conveying device and a plate-shaped body in the vicinity of a rotary cutter included in a cutting device of the related art.

FIG. 2B is an explanatory view of a positional relationship between a conveying device and a plate-shaped body in the vicinity of a rotary cutter included in the cutting device according to the embodiment of the present invention.

FIG. 3A is an explanatory view of a configuration example of a lifting device.

FIG. 3B is an explanatory view of a configuration example of the lifting device.

FIG. 3C is an explanatory view of a configuration example of the lifting device.

FIG. 3D is an explanatory view of a configuration example of the lifting device.

FIG. 3E is an explanatory view of a configuration example of the lifting device.

FIG. 3F is an explanatory view of a configuration example of the lifting device.

FIG. 4 is an explanatory view of a gypsum plate manufacturing apparatus according to the embodiment of the present invention.

### DETAILED DESCRIPTION OF THE INVENTION

Hereinafter, embodiments for carrying out the present invention will be described with reference to the drawings, but the present invention is not limited to the following embodiments, and various modifications and substitutions can be made to the following embodiments without departing from the scope of the present invention.

### [Cutting Device]

Hereinafter, a cutting device according to the present embodiment will be described with reference to the drawings.

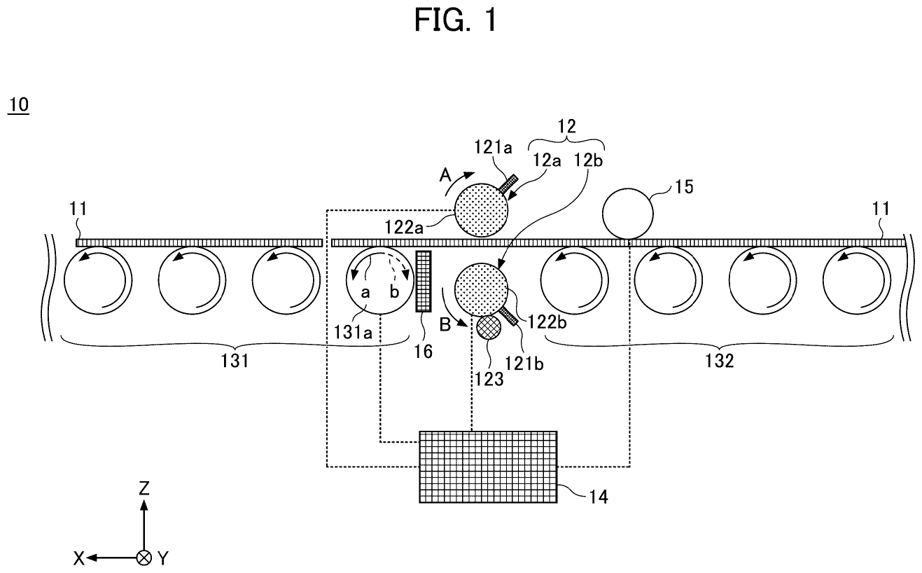

FIG. 1 is a side view of a configuration example of the cutting device 10 of the present embodiment.

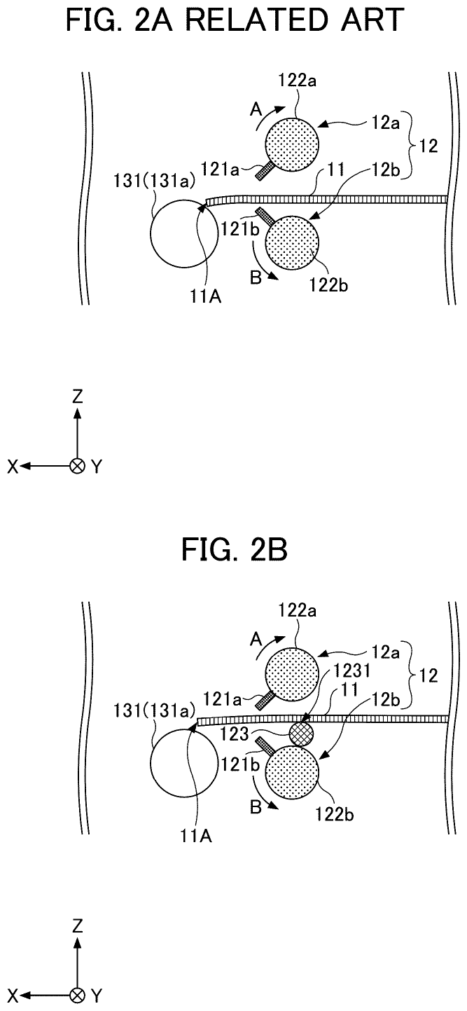

FIG. 2A is an explanatory view of a positional relationship between a conveying device and a plate-shaped body when the plate-shaped body is cut by a rotary cutter of the related art. FIG. 2B is an explanatory view of a positional relationship between a conveying device and a plate-shaped body when the plate-shaped body is cut by a rotary cutter included in the cutting device of the present embodiment.

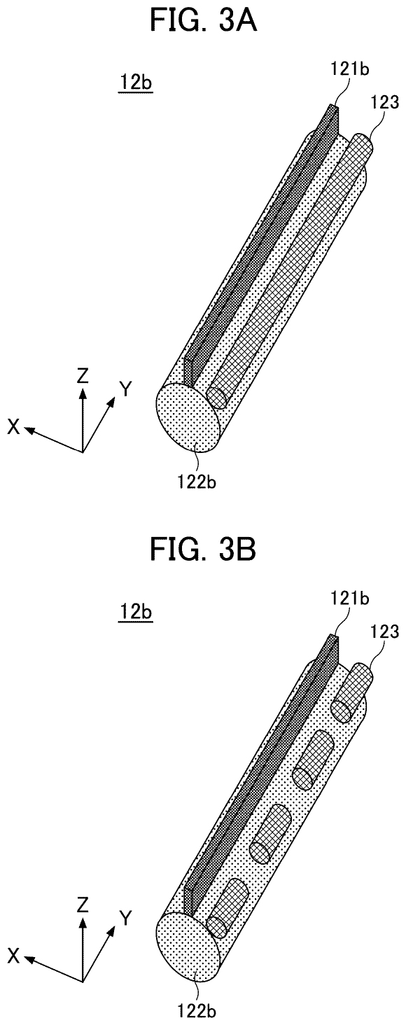

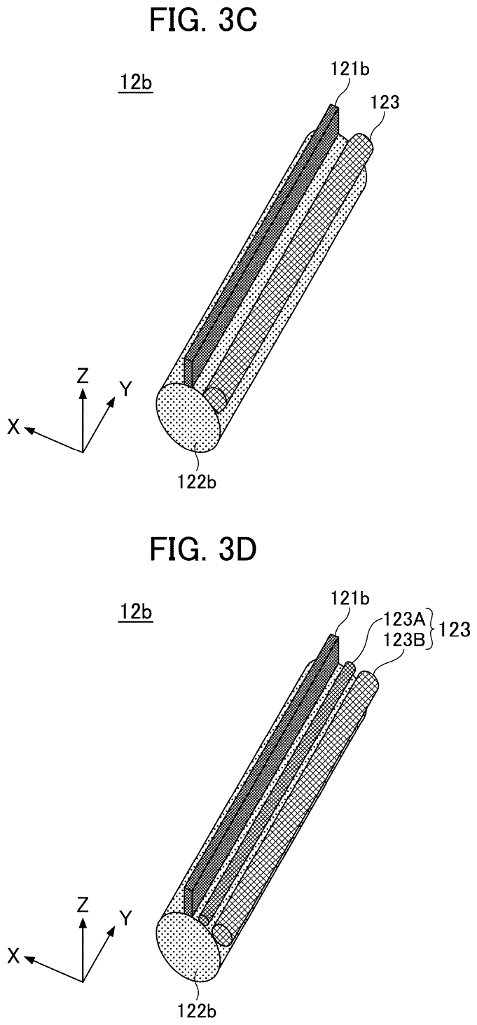

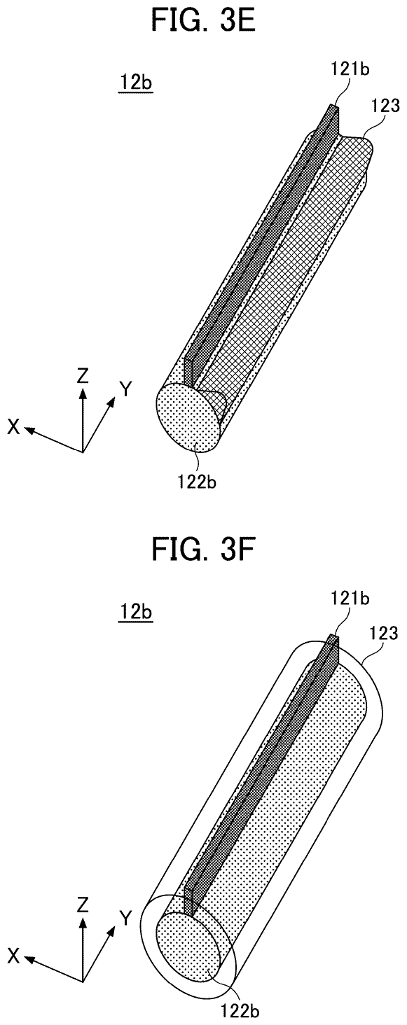

Each of FIGS. 3A to 3F illustrates a configuration example of a lifting device.

The X axis in FIGS. 1, 2A, 2B, and 3A to 3F indicates a conveying direction of the plate-shaped body. The Y axis is an axis extending along a length of a roll included in the rotary cutter and extending along a width of the plate-shaped body. The Z axis indicates a height direction. In FIG. 1, the plate-shaped body 11 is conveyed from right to left along the X axis. The above drawings are drawings for schematically describing the configuration of the cutting device of the present embodiment. Thus, the sizes and the like are not accurately reflected.

The cutting device of the present embodiment is a cutting device 10 that cuts a plate-shaped body 11 being conveyed.

The cutting device 10 of the present embodiment includes a rotary cutter 12 that includes a lower unit 12b, where the lower unit 12b is disposed below the plate-shaped body 11 and includes a roll 122b and a lower blade 121b attached to the roll 122b. Moreover, the cutting device 10 of the present embodiment includes a lifting device 123 that is disposed on the lower unit 12b, and lifts up the plate-shaped body 11.

### (1) Members Included in Cutting Device

Each member included in the cutting device 10 will be described hereinafter.

### (1-1) Rotary Cutter

As illustrated in FIG. 1, the rotary cutter 12 includes the lower unit 12b disposed below the plate-shaped body 11.

The lower unit 12b includes, as illustrated in FIG. 1, the roll 122b parallel to the Y axis, and the lower blade 121b attached to the roll 122b.

The rotary cutter 12 may further include an upper unit 12a. In a similar manner to the lower unit 12b, the upper unit 12a includes a roll 122a parallel to the Y axis, and an upper blade 121a attached to the roll 122a.

The rotary cutter 12 can rotate the upper unit 12a and the lower unit 12b in directions of arrows A and B depicted in FIG. 1, respectively. The rotary cutter 12 is configured such that, when the plate-shaped body 11 reaches a position at which the upper blade 121a of the upper unit 12a and the lower blade 121b of the lower unit 12b face each other, the plate-shaped body 11 is pressed between and cut by the upper blade 121a and the lower blade 121b.

In the case where the plate-shaped body 11 is to be cut, the plate-shaped body 11 is typically desired to be cut along a cut line provided along a width of the plate-shaped body 11 to divide the plate-shaped body 11. Therefore, both the upper blade 121a and the lower blade 121b are preferably continuously disposed in the longitudinal direction of the roll 122a and in the longitudinal direction of the roll 122b, respectively.

Moreover, each of the roll 122a and the roll 122b has a rotational axis along the Y axis, and can be respectively rotated in the directions of the arrow A and the arrow B, as described above. Therefore, each of the roll 122a and the roll 122b is coupled to a driving device (not illustrated), such as a motor or the like.

### (1-2) Lifting Device

As described above, in the case where the plate-shaped body is cut by the rotary cutter, a cut surface of the plate-shaped body may come into contact with a conveying device disposed downstream of the rotary cutter in the conveying direction of the plate-shaped body. The inventors of the present invention have studied the cause of the above phenomenon.

Here, FIG. 2A illustrates an enlarged view of the vicinity of a rotary cutter 12 of the related art and a downstream-side conveying device 131 arranged downstream of the rotary cutter 12 in a conveying direction of the plate-shaped body 11. As illustrated in FIG. 2A, in the case where the plate-shaped body 11 is cut by the rotary cutter 12, the plate-shaped body 11 may be bent or sag downward in the vicinity of the cut surface 11A depending on a material, thickness, and the like of the plate-shaped body 11. This is because the portion of the plate-shaped body in the vicinity of the cut surface 11A has been supported by the remaining portion of the cut plate-shaped body before cutting owing to the plate-shaped body constituting an integrated body, but loses the support after cutting so that the weight of the portion in the vicinity of the cut surface 11A cannot be supported by the cut plate-shaped body. Therefore, the cut surface 11A of the plate-shaped body 11, especially corners of the cut surface 11A, comes into contact with the downstream-side conveying device 131 arranged on the downstream side in the conveying direction of the plate-shaped body 11.

Therefore, the inventors of the present invention further conducted studies. Then, the inventors studied a configuration in which a lifting device 123 for lifting the plate-shaped body 11 is arranged in the lower unit 12b as illustrated in FIG. 2B. As a result, it has been found that the position of the cut surface 11A of the plate-shaped body 11 can be displaced upward by the lifting device 123, thereby preventing the contact between the cut surface 11A of the plate-shaped body 11 and the downstream-side conveying device 131, even when the plate-shaped body 11 is bent, which leads to the present invention.

Thus, the cutting device 10 of the present embodiment can include the lifting device 123. Since the cutting device 10 includes the lifting device 123, even when the plate-shaped body is bent in the vicinity of the cut surface 11A, the plate-shaped body 11 can be prevented from coming into contact with the downstream-side conveying device 131. Therefore, the deposition of the material of the plate-shaped body 11 on the downstream-side conveying device 131 serving as a conveying device, or damage to the plate-shaped body 11, can be minimized.

A configuration of the lifting device 123 is not particularly limited, as long as the lifting device 123 is configured to lift up the plate-shaped body 11 after cutting of the plate-shaped body 11 by the rotary cutter 12.

Therefore, as illustrated in FIG. 1, the lifting device 123 can be arranged, for example, at a position where the lifting device 123 comes into contact with the plate-shaped body 11 cut by the lower blade 121b, when the roll 122b included in the lower unit 12b is rotated along the arrow B. Specifically, the lower blade 121b and the lifting device 123 are sequentially arranged on the roll 122b of the lower unit 12b in the rotational direction of the roll 122b. The time span from cutting of the plate-shaped body 11 to lifting performed by the lifting device 123 can also be adjusted by selecting a distance between the lower blade 121b and the lifting device 123 in the rotational direction of the roll 122b.

A shape of the lifting device 123 is not particularly limited, but a shape that makes it possible to lift up the plate-shaped body 11 can be selected. When the lifting device 123 lifts up the plate-shaped body 11, no flaw is preferably caused on a bottom surface of the plate-shaped body 11. Therefore, a portion of the lifting device 123 that comes into contact with the plate-shaped body 11 is preferably a curved surface. Since the portion of the lifting device 123 that comes into contact with the plate-shaped body 11 is a curved surface, when the lifting device 123 comes into contact with the plate-shaped body 11, a force can be inhibited from being locally applied to the plate-shaped body 11, thereby preventing the plate-shaped body 11 from being largely deformed or flaws from being caused on the plate-shaped body 11. For example, as illustrated in FIG. 2B, the portion 1231 of the lifting device 123 that comes into contact with the plate-shaped body 11 on a plane of the roll 122b perpendicular to the longitudinal direction of the roll 122b is preferably curved, and more preferably curved upward in a convex shape.

A shape of the lifting device 123 is not particularly limited, but the lifting device 123 can have a columnar shape in the longitudinal direction of the roll 122b.

For example, as illustrated in FIGS. 1 and 3A, a cross-section of the lifting device 123 cut perpendicularly to the longitudinal direction of the roll 122b may be a circular shape, and the entire shape of the lifting device 123 may be a cylindrical shape. The circular shape may be a perfect circle or an oval.

The lifting device 123 having a single continuous cylindrical shape in the longitudinal direction of the roll 122b is illustrated in FIG. 3A, but the lifting device 123 is not limited to the illustrated embodiment. For example, multiple lifting devices 123, each having a shorter length than a length of the roll 122b in the longitudinal direction, may be arranged on the roll 122b in the longitudinal direction, as illustrated in FIG. 3B. Specifically, the lifting device 123 may be arranged intermittently in the longitudinal direction of the roll 122b. In the case where multiple lifting devices 123 are arranged on the roll 122b in the longitudinal direction of the roll 122b, cross-sectional shapes of the lifting devices 123 cut perpendicularly to the longitudinal direction of the roll 122b are preferably identical.

However, the lifting device 123 is preferably continuously disposed on the roll 122b in the longitudinal direction of the roll 122b, as illustrated in FIG. 3A and the like. Since the lifting device 123 is continuously disposed in the longitudinal direction of the roll 122b, a bottom surface of the plate-shaped body 11 can be uniformly pressed along a width of the plate-shaped body 11, and therefore, particularly, the plate-shaped body 11 can be prevented from causing, particularly, flaws or the like.

As illustrated in FIG. 3C, a cross-section of the lifting device 123 cut perpendicularly to the longitudinal direction of the roll 122b may be a semicircular shape, and an entire shape of the lifting device 123 may be a semi-cylindrical shape.

As illustrated in FIG. 3D, the lifting device 123 may be composed of multiple members arranged along an outer periphery of the roll 122b. For example, the lifting devices 123A and 123B having mutually different sizes can be disposed along the outer periphery of the roll 122b, as illustrated in FIG. 3D. Some or all of the lifting devices may have the same size. Specifically, for example, cylindrical lifting devices 123A and 123B having mutually different outer diameters and cross-sectional areas can be disposed along the outer periphery of the roll 122b, as illustrated in FIG. 3D. By providing the multiple lifting devices 123 having mutually different sizes along the outer periphery of the roll 122b, the degree of lifting of the plate-shaped body 11 can be changed according to the rotation of the roll 122b, thereby precisely adjusting the degree of lifting of the plate-shaped body 11. Therefore, the plate-shaped body 11 can be particularly prevented from causing flaws or the like. Although the example in which two lifting devices 123A and 123B having mutually different sizes are arranged is illustrated in FIG. 3D, three or more lifting devices may be arranged. Although the example in which both the lifting devices 123A and 123B have a cylindrical shape is illustrated in FIG. 3D, the shapes of the lifting devices 123A and 123B are not limited to the above embodiment. In the case where the lifting device 123 includes multiple members, some or all of the members may have a different shape than other members.

As illustrated in FIG. 3E, a plane of the lifting device 123 perpendicular to the longitudinal direction of the roll 122b may have an irregular shape. In FIG. 3E, the example in which the plane of the lifting device 123 perpendicular to the longitudinal direction of the roll 122b has a shape that looks like a triangle with a rounded vertex is illustrated, but the shape of the plane is not limited to the above shape. The cross-sectional shape of the lifting device 123 can be selected according to a required degree of lifting of the plate-shaped body 11.

As illustrated in FIG. 3F, the lifting device 123 can be arranged to cover an outer surface of the roll 122b. The lifting device 123 illustrated in FIG. 3F can be arranged along the outer surface of the roll 122b. The lifting device 123 illustrated in FIG. 3F can be a plate body that provides a void between the roll 122b and the lifting device 123. The lifting device 123 illustrated in FIG. 3F may have a support or the like between the lifting device 123 and the roll 122b.

A cross-section of the lifting device 123 illustrated in FIG. 3F cut perpendicularly to the longitudinal direction of the roll 122b can have a circular shape from which a portion corresponding to the lower blade 121b is removed. The circular shape may be a perfect circle or an oval. Moreover, the lifting device 123 illustrated in FIG. 3F does not necessarily completely cover the outer surface of the roll 122b. For example, the cross-section of the lifting device 123 cut perpendicularly to the longitudinal direction of the roll 122b may be a part of a circle, i.e., an arc shape.

The lifting device 123 illustrated in FIG. 3F may be fixed on the outer surface of the roll 122b, or may be fixed on the lower blade 121b or a fixing member (not illustrated) or the like for fixing the lower blade 121b.

The lifting devices 123 illustrated in FIGS. 3C to 3F are illustrated as examples where the lifting device 123 is continuously disposed in the longitudinal direction of the roll 122b, but the lifting device 123 may be intermittently disposed in the longitudinal direction of the roll 122b as described with reference to FIG. 3B.

A material of the lifting device 123 is not particularly limited, and may be a metal, such as stainless steel, steel, and the like, or a resin or the like. The lifting device 123 can include both a metal and a resin. In the case where the lifting device 123 is formed of a resin, the lifting device 123 may be a foam body or the like including pores therein.

The lifting device 123 can be configured such that a size of the lifting device 123, such as the outer diameter or the like, is changeable. Specifically, the lifting device 123 may be configured such that, for example, at least one medium selected from gases and liquids is supplied into or discharged from the lifting device 123 to change the size of the lifting device 123, such as the outer diameter or the like. In this case, the lifting device 123 can include an extendable outer peripheral portion, a medium reservoir that is covered with the outer peripheral portion and can accommodate the medium, and a pipe coupled to the medium reservoir. Moreover, the lifting device 123 may further include an external vessel, which is coupled to the pipe and stores a medium to be supplied to the medium reservoir, a pump for transporting the medium to the medium reservoir, a valve attached to the pipe, and the like.

Since the outer peripheral portion is preferably configured to be repetitively expandable, for example, a resin or the like is preferably used as a material of the outer peripheral portion. Moreover, as the medium, water or air, which is readily available and inexpensive, is preferably used.

The lifting device 123 configured to be changeable in size may be configured such that the medium is automatically supplied to and discharged from the medium reservoir to achieve a desired size of the lifting device 123. In this case, the lifting device 123 preferably further includes a control device to control operations of the pump, the valve, and the like.

Moreover, the lifting device 123 configured to be changeable in size may be configured such that the medium is supplied to and discharged from the medium reservoir by manually operating the pump or the like. A partial section of the pipe, the external vessel, the pump, and the like may be configured to be detachable, provided that operations of the lower unit 12b or the like are not hindered.

The lifting device 123 and the roll 112b may constitute an integrated body. Alternatively, the lifting device 123 may be detachably mounted on the roll 122b with screws or the like.

A size of the lifting device 123 is not particularly limited, and can be selected according to a distance between the rotary cutter 12 and the downstream-side conveying device 131, a material of the plate-shaped body 11, and the like. For example, the size of the lifting device 123 can be selected so as to ensure a degree of lifting of the plate-shaped body 11 by which the cut surface 11A of the plate-shaped body 11 does not come into contact with the downstream-side conveying device 131.

The cutting device 10 of the present embodiment can further include optional members.

### (1-3) Control Device and Length Measuring Device

As illustrated in FIG. 1, the cutting device 10 of the present embodiment can further include a control device 14 that controls rotational speed of the roll 122b of the lower unit 12b.

The control device 14 controls the rotational speed of the roll 122b of the lower unit 12b, thereby adjusting the timing of contact between the plate-shaped body 11 and the lifting device 123. Since the cutting device 10 of the present embodiment includes the control device 14, the timing of lifting of the plate-shaped body 11 can be adjusted.

Here, the example in which the timing of the contact between the plate-shaped body 11 and the lifting device 123 is adjusted by controlling the rotational speed of the roll 122b with the control device 14 is illustrated, but a method and embodiment of adjusting the timing of the contact between the plate-shaped body 11 and the lifting device 123 are not limited.

For example, the timing of the contact between the plate-shaped body 11 and the lifting device 123 can be adjusted by shifting the position of the lifting device 123 on the roll 122b in the circumferential direction of the roll 122b.

Moreover, the timing of the contact between the plate-shaped body 11 and the lifting device 123 may be adjusted by changing a size of the lifting device 123.

For example, multiple lifting devices 123 having mutually different outer diameters or the like can be prepared. In this case, the lifting devices 123 having mutually different outer diameters are preferably configured to be detachable from the roll 122b. By selecting an appropriate size of the lifting device 123 according to the specification or the like of the plate-shaped body 11 and mounting the selected lifting device 123 on the roll 122b, the timing of the contact between the plate-shaped body 11 and the lifting device 123 can be adjusted.

Alternatively, the lifting device 123 configured to be changeable in size, such as an outer diameter or the like, can be mounted on the roll 122b. By automatically or manually adjusting the size of the lifting device 123 to an appropriate size according to the specification of the plate-shaped body 11, the timing of the contact between the plate-shaped body 11 and the lifting device 123 can be adjusted.

The control device 14 can also control rotational speed of the roll 122a of the upper unit 12a. The control device 14 can control the rotational speed of the roll 122a of the upper unit 12a so that the plate-shaped body 11 can be cut by a desired length according to a length of a plate-shaped body 11 to be produced. In this case, the control device 14 can also control the rotational speed of the roll 122b of the lower unit 12b in addition to the rotational speed of the roll 122a of the upper unit 12a.

The cutting device 10 of the present embodiment can include a length measuring device 15 that measures a length of the plate-shaped body 11. The length measuring device 15 can measure a length of the plate-shaped body 11 being conveyed. In FIG. 1, a configuration example of a contact-type length measuring device is illustrated as the length measuring device 15, but the length measuring device is not limited to the above embodiment, and may be a non-contact type length measuring device.

The control device 14 may control rotational speed of the roll 122a of the upper unit 12a or rotational speed of the roll 122b of the lower unit 12b so that the plate-shaped body 11 can be cut by a desired length, based on the length of the plate-shaped body 11 measured by the length measuring device 15.

The control device 14 can individually control the speed of the roll 122a in the upper unit 12a, and the speed of the roll 122b in the lower unit 12b. Note that the roll 122a and the roll 122b are not necessarily rotated at a constant speed, and the rotational speed may be varied.

The control device 14 can include a CPU, which is an arithmetic processing unit for performing calculations necessary for control, a RAM or ROM, which is a main storage device, an auxiliary storage device, an input/output interface, a display device, which is an output device, and the like. The CPU, the main storage device, the auxiliary storage device, the input/output interface, and the output device included in the control device 14 can be connected to one another via a bus. All of the above components included in the control device 14 are not necessarily accommodated in one housing. For example, the auxiliary storage device or the display device may be externally provided. The auxiliary storage device is a storage device, such as an SSD, HDD, and the like.

Note that “CPU” is an abbreviation of “central processing unit”; “RAM” is an abbreviation of “random access memory”; and “ROM” is an abbreviation of “read only memory.” In addition, “SSD” is an abbreviation of “solid state drive” and HDD is an abbreviation of “hard disk drive.”

Examples of the input/output interface include wired and wireless interfaces for exchanging data, such as detection data of the length measuring device 15, a control amount of a driving device (not illustrated) that drives the roll 122a and the roll 122b, and the like.

Examples of the input/output interface also include user interfaces, such as a touch panel, a keyboard, operation buttons, and the like.

The control device 14 can be constructed by a personal computer (PC) or the like. Thus, the above components included in the control device 14 may be implemented in cooperation with software and hardware by executing one or more programs stored in the CPU in advance.

The control device 14 can also control, for example, conveyance speed or the like of the downstream-side conveying device 131, or the like, in addition to the above members. The example in which the cutting device 10 includes one control device 14 is illustrated in FIG. 1, but control can be performed by multiple control devices. In this case, the control devices are preferably configured such that data can be exchanged between the control devices.

### (1-4) Downstream-Side Conveying Device

The cutting device 10 can include the downstream-side conveying device 131 disposed downstream of the rotary cutter 12 in a conveyance path of the plate-shaped body 11. The plate-shaped body 11 cut by the rotary cutter 12 can be conveyed toward an arbitrary device or the like by the downstream-side conveying device 131.

The downstream-side conveying device 131 is not particularly limited, as long as the downstream-side conveying device 131 can support and convey the plate-shaped body 11. For example, at least one device selected from a conveyor, a roller conveyor, and the like is preferably used.

For example, the example in which a roller conveyor is used as the downstream-side conveying device 131 is illustrated in FIG. 1, but the downstream-side conveying device 131 is not limited to the above embodiment. Part of or the entire downstream-side conveying device 131 can be a belt conveyor.

However, the downstream-side conveying device 131 preferably includes at least a conveying roll 131a disposed immediate downstream of the rotary cutter 12. In this case, the conveying roll 131a is preferably configured such that a rotational direction of the conveying roll 131a can be controlled by the above-described control device 14 or the like.

A single conveying roll 131a is disposed immediately downstream of the rotary cutter 12, and the conveying roll 131a is rotated in a direction of the arrow b indicated with a dashed line in FIG. 1, which is opposite to the conveying direction of the plate-shaped body 11, so that foreign matter deposited on a surface of the conveying roll 131a can be dropped off.

As described above, since the cutting device 10 of the present embodiment includes the lifting device 123, deposition of the material of the plate-shaped body 11 on the downstream-side conveying device 131 can be minimized. However, when the plate-shaped body 11 is cut by the rotary cutter 12, fragments or the like may be scattered and deposited on the conveying roll 131a disposed at the most upstream position in the conveying direction of the plate-shaped body 11 within the downstream-side conveying device 131. Therefore, the conveying roll 131a is configured to rotate in an opposite direction to the conveying direction of the plate-shaped body 11, thereby removing foreign matter. Thus, the transfer of the foreign matter from the conveying roll 131a to the bottom surface of the plate-shaped body 11 can be particularly minimized.

During normal operation, for example, the control device 14 can rotate the conveying roll 131a in the same direction as the conveying direction of the plate-shaped body 11, i.e., the direction of the arrow a indicated with a solid line in FIG. 1. In this case, the control device 14 may perform control so that the operational direction of the conveying roll 131a is reversed at an arbitrary timing to rotate in the direction of the arrow b indicated with the dashed line.

### (1-5) Foreign Matter Deposition Prevention Device

As described above, when the plate-shaped body 11 is cut by the rotary cutter 12, fragments may be scattered and deposited on the conveying roll 131a of the downstream-side conveying device 131. If foreign matter, such as fragments and the like, is deposited on the surface of the conveying roll 131a, the shape of the foreign matter, such as the fragments and the like, are transferred to the bottom surface of the conveyed plate-shaped body 11, which may result in the generation of a defective product that does not satisfy the standard.

Therefore, the cutting device 10 of the present embodiment can include a foreign matter deposition prevention device 16 between the rotary cutter 12 and the downstream-side conveying device 131. A configuration of the foreign matter deposition prevention device 16 is not particularly limited, and the foreign matter deposition prevention device 16 can be any device that can prevent foreign matter, such as fragments generated when the plate-shaped body 11 is cut by the rotary cutter 12, from being scattered and deposited on the downstream-side conveying device 131.

The foreign matter deposition prevention device 16 may be a barrier formed of an intangible object or a tangible object. By providing the barrier between the rotary cutter 12 and the downstream-side conveying device 131, foreign matter, such as fragments or the like, generated by the rotary cutter 12 can be prevented from being scattered or deposited on the downstream-side conveying device 131.

Examples of the foreign matter deposition prevention device 16 include a device that forms a barrier with a gas that is an intangible object, such as an air curtain (air curtain device), a plate-shaped or sheet-shaped barrier, and a device that forms a barrier with at least one tangible object selected from a sponge, a bristle brush, and a brush.

### (1-6) Upstream-Side Conveying Device

The cutting device 10 of the present embodiment can include an upstream-side conveying device 132 that conveys a plate-shaped body 11 to be cut to the rotary cutter 12. The example in which a roller conveyor is used as the upstream-side conveying device 132 is illustrated in FIG. 1, but the upstream-side conveying device 132 is not particularly limited as long as the upstream-side conveying device 132 can support and convey the plate-shaped body 11. As the upstream-side conveying device 132, for example, at least one device selected from a belt conveyor, a roller conveyor, and the like can be preferably used.

### (1-7) Others

In order to remove foreign matter deposited on a top surface of the plate-shaped body 11 being conveyed, the cutting device 10 of the present embodiment can further include a top-surface-side air supply device (not illustrated) that blows air against the top surface of the plate-shaped body 11 to remove the foreign matter.

Moreover, the cutting device 10 of the present embodiment can include a scraper or the like disposed to be in contact with a surface of the rotating conveying roll 131a to remove the foreign matter deposited on the conveying roll 131a.

### (2) Regarding Plate-Shaped Body

The plate-shaped body 11 to be cut by the cutting device 10 of the present embodiment is not particularly limited, and may be any plate-shaped object to be cut. Accordingly, a final product or a semi-finished product that is in the middle of production or processing can serve as the plate-shaped body 11 to be applied to the cutting device 10 of the present embodiment.

Semi-finished products, in particular, may often be cut into a predetermined size while being conveyed, and are easily bent due to not having sufficient strength. In the case where the plate-shaped body 11 is a semi-finished product, the cutting device 10 of the present embodiment exhibits a particularly significant effect. Therefore, the plate-shaped body 11 is preferably a semi-finished product.

In the case where the plate-shaped body 11 is a semi-finished product, the semi-finished product may include a molded product of one or more selected from ceramics, resins, or the like, on which drying, or firing, or both are not performed, or in which a reaction, such as hardening or the like, has not progressed. Examples thereof include an unhardened gypsum plate, a green sheet, and the like. The “reaction such as hardening or the like has not progressed” includes a case where a reaction such as hardening or the like has partially progressed, but not completely progressed.

Moreover, examples of a final product of the above semi-finished product, which is one or more selected from ceramics, resins, or the like, include building materials, such as a gypsum plate and the like, members for electronic components, structural materials, and the like.

The gypsum plate is, for example, any gypsum plate selected from a glass mat gypsum board, a gypsum plate including a glass-fiber nonwoven fabric, a gypsum board specified by JIS A 6901 (2014), a gypsum board that is lighter or heavier than the gypsum board specified by JIS A 6901 (2014) (the gypsum board specified by the above JIS, and the gypsum board that is lighter or heavier than the gypsum board specified by the above JIS may be collectively referred to as a “gypsum board”), a slag gypsum plate, other gypsum plates, and the like.

The glass mat gypsum board is, for example, a gypsum plate in which a surface of the gypsum plate is covered with a glass mat.

The gypsum plate including the glass-fiber nonwoven fabric is, for example, a gypsum plate in which a glass-fiber nonwoven fabric (glass tissue) is embedded in a surface side of the gypsum plate.

Moreover, the gypsum board is, for example, a gypsum board in which a surface of the gypsum board is covered with board base paper.

Other gypsum plates are gypsum plates that are not classified into any of the above gypsum plates. Examples thereof include a gypsum plate that does not have surface paper serving as a covering material.

As described above, a final product can also be used as the plate-shaped body 11 to be cut.

A thickness or the like of the plate-shaped body 11 is not particularly limited, and may be suitably selected according to a cutting capability or the like of the rotary cutter 12.

### [Plate-Shaped Body Manufacturing Apparatus and Gypsum Plate Manufacturing Apparatus]

Next, one configuration example of the plate-shaped body manufacturing apparatus and the gypsum plate manufacturing apparatus of the present embodiment will be described.

The plate-shaped body manufacturing apparatus of the present embodiment can include the above-described cutting device.

Moreover, as the plate-shaped body, for example, a gypsum plate can be produced. In this case, the plate-shaped body manufacturing apparatus can be a gypsum plate manufacturing apparatus. Therefore, the gypsum plate manufacturing apparatus of the present embodiment can similarly include the above-described cutting device.

A type of the gypsum plate produced by the gypsum plate manufacturing apparatus of the present embodiment or the below-described gypsum plate manufacturing method is, as described above, any one gypsum plate selected from a glass mat gypsum board, a gypsum plate including a glass-fiber nonwoven fabric, a gypsum board, a slag gypsum plate, other gypsum plates, and the like.

The plate-shaped body manufacturing apparatus and gypsum plate manufacturing apparatus of the present embodiment can include, in addition to the above-described cutting device, various devices and components necessary for producing a plate-shaped body.

In the case where it is necessary to mix raw materials, for example, the plate-shaped body manufacturing apparatus and gypsum plate manufacturing apparatus of the present embodiment can include a mixing device (mixer) for mixing raw materials. Moreover, the plate-shaped body manufacturing apparatus and gypsum plate manufacturing apparatus of the present embodiment can include a molding device or the like that molds and processes the raw materials, the raw material mixture prepared by the mixing device, raw material slurry, or the like into a desired shape or size.

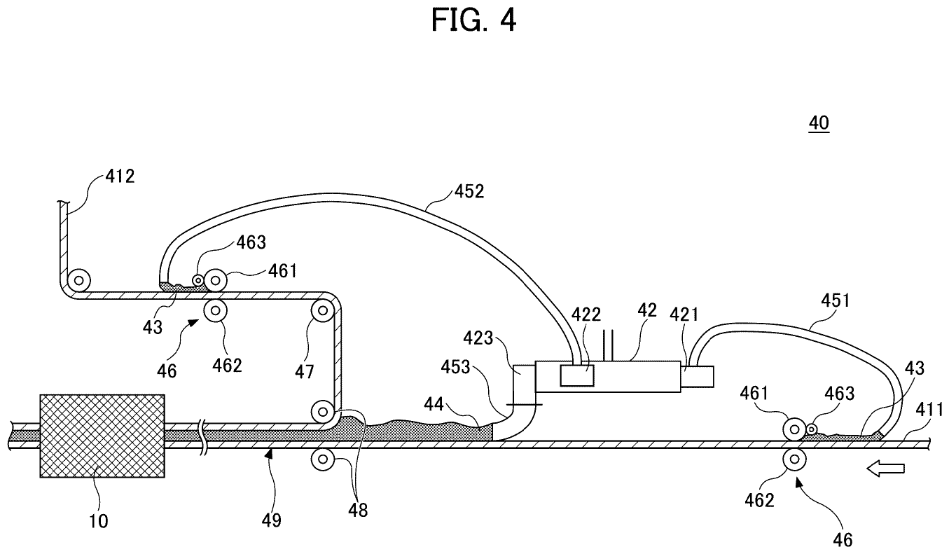

As a configuration example of the plate-shaped body manufacturing apparatus and gypsum plate manufacturing apparatus of the present embodiment, a configuration of a device will be described hereinafter through an example in which a plate-shaped body and a gypsum board that is a gypsum plate are produced with reference to FIG. 4.

The gypsum plate manufacturing apparatus 40 illustrated in FIG. 4 includes, in addition to the above-described cutting device 10, a mixer 42 as a mixing device for mixing raw materials, and a molding machine 48 for molding gypsum slurry prepared by the mixer 42. A configuration example of the apparatus will be specifically described hereinafter.

### (1) Mixer

The mixer 42 can be arranged at a predetermined position with respect to conveyance lines of first board base paper 411, second board base paper 412, and the like, which are covering materials. For example, the mixer 42 can be arranged above or alongside the conveyance lines. In a single mixer 42, gypsum slurry can be prepared by kneading calcined gypsum and water, and optionally various additives and foam, which are raw materials of gypsum slurry.

The calcined gypsum is also called calcium sulfate hemihydrate, and is an inorganic composition having a hydraulic hardening property. As the calcined gypsum, β-calcined gypsum or α-calcined gypsum can be used alone, or a mixture of β-calcined gypsum and α-calcined gypsum can be used. The β-calcined gypsum is obtained by calcining one of or a mixture of natural gypsum, by-product gypsum, flue-gas gypsum, and recycled gypsum, such as a waste gypsum board, and the like in the atmosphere. The α-calcined gypsum is obtained by calcining one of or a mixture of natural gypsum, by-product gypsum, flue-gas gypsum, and recycled gypsum, such as a waste gypsum board and the like, in water (including in steam).

When a gypsum plate is manufactured, the calcined gypsum used as a raw material preferably includes β-calcined gypsum, and more preferably, a main component of the calcined gypsum used as the raw material of the gypsum plate is β-calcined gypsum. Note that “the main component of the calcined gypsum used as the raw material of the gypsum plate is β-calcined gypsum” means that a mass percentage of β-calcined gypsum in the calcined gypsum used as the raw material of the gypsum plate is greater than 50%. For manufacturing of a gypsum plate, the calcined gypsum used as the raw material may be composed solely of β-calcined gypsum.

In order to produce α-calcined gypsum, it is necessary to pressure-calcine dihydrate gypsum, such as natural gypsum and the like, in water or stream using an autoclave. Conversely, β-calcined gypsum can be produced by calcining dihydrate gypsum, such as natural gypsum and the like, under normal pressure in the atmosphere. Thus, β-calcined gypsum can be produced at higher productivity as compared to α-calcined gypsum.

The additives are, for example, one or more selected from: adhesion improvers, such as starch, polyvinyl alcohol, and the like, for improving the adhesion between a hardened gypsum body (hardened gypsum slurry) and board base paper; inorganic fibers, such as glass fibers and the like; lightweight aggregates; refractory materials, such as vermiculite and the like; setting retarders; setting accelerators; water-reducing agents; foaming agents, such as sodium alkyl sulfates, alkyl ether sulfates, sodium alkylbenzene-based sulfonates, polyoxyethylene alkyl sulfates, and the like; foam size adjusting agents, such as sulfosuccinate surfactants and the like; water repellents, such as silicone, paraffin, and the like; organic carboxylic acids; organic carboxylates; and the like.

Note that calcined gypsum and some of the additives, such as solid additives, may be mixed and stirred in advance to prepare the mixture as a gypsum composition, and the gypsum composition may be supplied to the mixer 42.

Moreover, foam may be added from one or more of gypsum slurry dispensing ports 421, 422, and 423, and an amount of the foam added is adjusted to obtain gypsum slurry having a desired density. For example, foam is not added or a small amount of foam is added from the dispensing ports 421 and 422 so that high-density first gypsum slurry 43 can be prepared. In addition, a larger amount of foam, as compared to the first gypsum slurry 43, can be added from the dispensing port 423 to prepare low-density second gypsum slurry 44.

Then, the obtained first gypsum slurry 43 is supplied through delivery pipes 451 and 452 onto the first board base paper 411 and the second board base paper 412 at positions upstream of the roller coaters 46 in the conveying direction of the board base paper.

The high-density first gypsum slurry 43 supplied onto the first board base paper 411 and the high-density first gypsum slurry 43 supplied onto the second board base paper 412 reach spreading sections of the roller coaters 46 and are spread at the spreading sections, respectively. Each of the roller coaters 46 can include a coating roller 461, a receiving roller 462, and a glue removal roller 463. When the first board base paper 411 or the second board base paper 412 passes between the coating roller 461 and the receiving roller 462, the first gypsum slurry 43 can be spread on the first board base paper 411 or the second board base paper 412.

In this manner, a thin layer of the first gypsum slurry 43 is formed on the first board base paper 411. Then, the first board base paper 411 is folded in a manner such that the side edges of the first board base paper 411 extend upward and then extend inward. A thin layer of the first gypsum slurry 43 is also formed on the second board base paper 412, but unlike the first board base paper 411, the second board base paper 412 is not folded. Note that the present embodiment is not limited to the embodiment in which the first gypsum slurry 43 is coated on both the first board base paper 411 and the second board base paper 412. For example, the first gypsum slurry 43 may be coated on either the first board base paper 411 or the second board base paper 412. Moreover, the first gypsum slurry 43 may be arranged only on the side edges of the first board base paper 411, which are the ends of the first board base paper 411 in the width direction.

The first board base paper 411 is then conveyed in the same conveying direction. The conveying direction of the second board base paper 412 is changed by a turning roller 47 to be toward the conveyance line of the first board base paper 411.

### (2) Molding Machine

The first board base paper 411 and second board base paper 412 being conveyed inside the gypsum plate manufacturing apparatus 40 reach the molding machine 48. The second gypsum slurry 44 is supplied between the thin layer of the first gypsum slurry 43 formed on the first board base paper 411 and the thin layer of the first gypsum slurry 43 formed on the second board base paper 412, from the mixer 42 via a pipe line 453. As a result, a continuous stacked body, in which a layer of the first gypsum slurry 43, a layer of the second gypsum slurry 44, and a layer of the first gypsum slurry 43 are stacked, can be formed between the first board base paper 411 and the second board base paper 412.

Note that the present embodiment is not limited to the embodiment in which the high-density first gypsum slurry 43 and the low-density second gypsum slurry 44 are used. For example, an embodiment in which gypsum slurry of a single density is produced and supplied onto board base paper may be applied.

Specifically, for example, gypsum slurry having a predetermined density is supplied and deposited on the first board base paper 411. Then, the ends of the first board base paper 411 in the width direction are folded along predetermined scored lines so as to extend upward and then extend inward. As a result, the deposited layer of the gypsum slurry is partially wrapped by the first board base paper 411. Thereafter, the second board base paper 412, which is conveyed at the same conveyance speed, can be stacked on the deposited layer of the gypsum slurry, which is partially wrapped by the first board base paper 411. The stacked body is then passed through the molding machine 48, which determines a thickness and width of a gypsum plate, to mold the stacked body. In the manner described above, a gypsum plate can also be used. In this case, a layer of gypsum slurry of a single density is formed between the first board base paper 411 and the second board base paper 412.

As described above, the molding machine 48 of the gypsum plate manufacturing apparatus 40 can perform the molding process of molding the gypsum slurry, thereby producing the gypsum slurry molded body 49.

### (3) Cutting Device

The gypsum plate manufacturing apparatus 40 of the present embodiment can include a cutting device 10 at a position downstream of the molding machine 48.

One or more cutting devices 10 may be provided as necessary. For example, a first cutting device (rough cutting device) that roughly cuts the manufactured gypsum plate in order to place the gypsum plate within a dryer can be provided. Moreover, a second cutting device that cuts the gypsum plate according to a size of a final product can be provided.

Since the cutting device 10 has been already described, the redundant description thereof is omitted here.

### (4) Dryer

The gypsum plate manufacturing apparatus 40 of the present embodiment can optionally include a dryer or the like, for example, at a position downstream of the molding machine 48.

The dryer can reduce the excess moisture in the gypsum slurry molded body.

Since each of the plate-shaped body manufacturing apparatus and the gypsum plate manufacturing apparatus of the present embodiment includes the above-described cutting device, even when the plate-shaped body is bent in the vicinity of the cut surface 11A, the contact between the plate-shaped body 11 and the downstream-side conveying device 131 can be prevented. Therefore, deposition of the material of the plate-shaped body 11 on the downstream-side conveying device 131 serving as the conveying device, or damage to the plate-shaped body 11 can be minimized.

### [Gypsum Plate Manufacturing Method]

The gypsum plate manufacturing method of the present embodiment includes a cutting process of cutting a molded body of gypsum slurry with the above-described cutting device.

The gypsum plate manufacturing method of the present embodiment can include, for example, a gypsum slurry preparation process, a molding process, a cutting process, and a hardening process.

In the gypsum slurry preparation process, calcined gypsum and water, and optionally various additives and foam, which are raw materials of gypsum slurry, are kneaded so that gypsum slurry can be prepared.

In the molding process, the gypsum slurry can be molded into a plate shape.

In the cutting process, the molded body of the gypsum slurry can be cut by the above-described cutting device.

In the hardening process, the plate-shaped molded body obtained in the molding process can be hardened.

Each of the above processes will be described through an example in which a gypsum plate to be produced is a gypsum board.

### (Gypsum Slurry Preparation Process)

In the gypsum slurry preparation process, the above-described calcined gypsum and water, and optionally various additives and foam are kneaded to prepare gypsum slurry.

For example, as described in association with the gypsum plate manufacturing apparatus, the above raw material components are kneaded by a mixer or the like so that gypsum slurry can be prepared. Since the raw materials of the gypsum slurry have been already described, the redundant description thereof is omitted here.

### (Molding Process)

In the molding process, the gypsum slurry obtained in the gypsum slurry preparation process can be molded into a plate shape. In the case where a gypsum plate to be manufactured is a gypsum board, in the molding process, the gypsum slurry is supplied between two pieces of board base paper to be molded into a plate shape.

For example, as described in association with the gypsum plate manufacturing apparatus, in the gypsum slurry molding process, high-density first gypsum slurry 43 and low-density second gypsum slurry 44 are formed in advance. In the molding process, a continuous stacked body, in which a layer of the high-density first gypsum slurry 43, a layer of the low-density second gypsum slurry 44, and a layer of the high-density first gypsum slurry 43 are stacked in this order, can be formed between the first board base paper 411 and the second board base paper 412. Subsequently, the stacked body is passed through the molding machine 48, which determines a thickness of a gypsum plate, to mold the stacked body into a plate shape, thereby forming a gypsum slurry molded body.

However, the present embodiment is not limited to the above embodiment. In the molding process, gypsum slurry of a desired density is supplied between two pieces of board base paper, and the gypsum slurry can be molded into a plate shape by the molding machine.

### (Cutting Process)

In the cutting process, the molded body of the gypsum slurry can be cut by the above-described cutting device.

After formation of the gypsum slurry molded body in the molding process, the gypsum slurry is gradually hardened. Therefore, the cutting process can be performed, for example, during the period when the below-described hardening process is performed, or after the hardening process is completed. However, it is preferable to perform the cutting process after the hardening process progresses to the extent that the gypsum slurry molded body can be cut.

The cutting process can also be performed multiple times. Thus, the gypsum plate manufacturing method of the present embodiment can include, for example, a first cutting process, which can also be referred to as a rough cutting process. In the first cutting process, the gypsum slurry molded body can be cut into a desired size according to a size of a dryer used in the below-described drying process or the like.

Moreover, a second cutting process can be performed, for example, after the drying process. In the second cutting process, the gypsum slurry molded body can be cut into a desired product size.

### (Hardening Process)

The hardening process can be performed after the molding process. The hardening process is a process of hardening the gypsum slurry molded body obtained in the molding process.

The hardening process can be performed by generating needle crystals of gypsum dihydrate through a hydration reaction of the calcined gypsum (gypsum hemihydrate) in the gypsum slurry, thereby setting and solidifying the gypsum slurry. Accordingly, in the hardening process, the calcined gypsum and water added to the gypsum slurry react with each other in the molded body formed in the molding process, and the hydration reaction of the calcined gypsum proceeds.

Moreover, the gypsum plate manufacturing method can further include any process. Specifically, the gypsum plate manufacturing method can include the following drying process.

### (Drying Process)

In the drying process, the gypsum slurry molded body can be dried. In the drying process, the excess moisture in the gypsum slurry molded body can be dried. Note that the molded body after completing the hardening process can be provided for the drying process. The drying process can be performed by forcibly drying the molded body using the dryer.

The method of forcibly drying the molded body using the dryer is not particularly limited. For example, a dryer is disposed in a conveyance path of the molded body, and the molded body can be continuously dried as the molded body passes through the dryer. Moreover, the molded body can be introduced into the dryer and the molded body can be dried for each batch.

Since the gypsum plate manufacturing method of the present embodiment uses the above-described cutting device in the cutting process, even when the plate-shaped body is bent in the vicinity of the cut surface 11A, the contact between the plate-shaped body 11 and the downstream-side conveying device 131 can be prevented. Thus, deposition of the material of the plate-shaped body 11 on the downstream-side conveying device 131 serving as the conveying device, or damage to the plate-shaped body 11 can be minimized.

### Additional Note

(1) A cutting device according to one embodiment of the present disclosure is a cutting device for cutting a plate-shaped body being conveyed. The cutting device includes: a rotary cutter including a lower unit, the lower unit being disposed below the plate-shaped body and including a roll and a lower blade attached to the roll; and a lifting device that is disposed on the lower unit, and lifts up the plate-shaped body.

(2) In (1), the lifting device is arranged at a position where which the lifting device comes into contact with the plate-shaped body cut by the lower blade, when the roll is rotated, and a portion of the lifting device coming into contact with the plate-shaped body may be a curved surface.

(3) In (1) or (2), the lifting device may have a columnar shape.

(4) In any one of (1) to (3), the lifting device may be disposed continuously in a longitudinal direction of the roll.

(5) In any one of (1) to (4), the cutting device may further include a control device that controls rotational speed of the roll.

(6) A plate-shaped body manufacturing apparatus according to one embodiment of the present disclosure includes the cutting device according to any one of (1) to (5).

(7) A gypsum plate manufacturing apparatus according to one embodiment of the present disclosure includes the cutting device according to any one of (1) to (5).

(8) A gypsum plate manufacturing method according to one embodiment of the present disclosure includes a cutting process of cutting a molded body of gypsum slurry, using the cutting device according to any one of (1) to (5).

Although the cutting device, the plate-shaped body manufacturing apparatus, the gypsum plate manufacturing apparatus, and the gypsum plate manufacturing method are described through embodiments thereof and the like, the present invention is not limited to the above embodiments and the like. Various modifications and changes can be made within the scope of the gist of the present invention described in the claims.

The present international application claims priority to Japanese Patent Application No. 2022-155885 filed on Sep. 29, 2022, the entire contents of which are incorporated into the present international application by reference.

### REFERENCE SIGNS LIST

10 cutting device
11 plate-shaped body
11A cut surface
12 rotary cutter
A, B arrow
12a upper unit
121a upper blade
122a roll
12b lower unit
121b lower blade
122b roll
123, 123A, 123B lifting device
131 downstream-side conveying device
131a conveying roll
a, b arrow
14 control device
15 length measuring device
16 foreign matter deposition prevention device
40 gypsum plate manufacturing apparatus
411 first board base paper
412 second board base paper
42 mixer
421, 422, 423 dispensing port
43 first gypsum slurry
44 second gypsum slurry
451, 452 delivery pipe
453 pipe line
46 roller coater
461 coating roller
462 receiving roller
463 glue removal roller
47 turning roller
48 molding machine
49 gypsum slurry molded body

1. A cutting device for cutting a plate-shaped body being conveyed, the cutting device comprising:
a rotary cutter including a lower unit, the lower unit being disposed below the plate-shaped body and including a roll and a lower blade attached to the roll; and
a lifting device that is disposed on the lower unit and lifts up the plate-shaped body.

2. The cutting device according to claim 1,
wherein the lifting device is arranged at a position where the lifting device comes into contact with the plate-shaped body cut by the lower blade, when the roll is rotated, and a portion of the lifting device that comes into contact with the plate-shaped body is a curved surface.

3. The cutting device according to claim 1,
wherein the lifting device has a columnar shape.

4. The cutting device according to claim 1,
wherein the lifting device is disposed continuously in a longitudinal direction of the roll.

5. The cutting device according to claim 1, further comprising:
a control device that controls a rotational speed of the roll.

6. A plate-shaped body manufacturing apparatus, comprising:
the cutting device according to claim 1.

7. A gypsum plate manufacturing apparatus, comprising:
the cutting device according to claim 1.

8. A gypsum plate manufacturing method, comprising:
a cutting process of cutting a molded body of gypsum slurry, using the cutting device according to claim 1.
